(19) United States
(12) Patent Application Publication
(10) Pub. No.: US 2006/0125345 A1
(43) Pub. Date: Jun. 15, 2006

(54) Direct current motor

(76) Inventor: Cheol-Gyun Lee, Busan (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/302,088

(22) Filed: Dec. 12, 2005

(30) Foreign Application Priority Data
Dec. 14, 2004 (KR) 10-2004-0105698

(51) Int. Cl. H02K 23/00; H02K 1/22; H02K 1/24

(52) U.S. Cl. 310/269; 310/264; 310/177; 310/261

(57) ABSTRACT

At least some portions of the rotator core are formed with non-magnetic materials to decrease the inductance of the coils of the rotator. This minimizesthe generation of a spark between the commutator and brush, thereby improving the durability of the brush and commutator. The cogging torque is also preventedby decreasing the magnetic flux density of the rotator, thus reliably reducing noise and vibration of the motor.

### CROSS-REFERENCE TO RELATED APPLICATIONS

The present application is based on, and claims priority from, Korean Application Serial Number 10-2004-0105698, filed on Dec. 14, 2004, the disclosure of which is hereby incorporated by reference herein in its entirety.

### TECHNICAL FIELD

The disclosed embodiments relate to motors, and more particularly, to a direct current motor having a relatively small inductance.

### BACKGROUND

A direct current (DC) motor is a device that generates rotational force by using DC power and generally includes a motor case, a stator, a rotator, a brush, a rotational shaft, and a commutator.

The commutator of a conventional DC motor is composed of a plurality of commutator bars with insulating materials in between. When the rotational shaft rotates, the brush contacts with the commutator bars and provides the current to each coil connected to the commutator bar.

However, the brush may be in contact with two commutator bars at the same time, if the rotational shaft rotates while the brush is in contact with a commutator bar. A short circuit flows in the coils connected to the shorted commutator bars.

The short circuit, then, gradually decreases due to the short circuit resistance and inductance thereof. Provided that the rotator rotates and the brush contacts with one commutator bar thereby, the commutation is completed.

Nevertheless, if the short circuit decreases insufficiently due to the coil having a high inductance while the rotator rotates and the brush contacts one commutator bar, a spark may be generated on the commutator bar detaching from the brush. The spark occurs due to instantaneous discharge of the electric energy stored in the coil.

The spark generated between the brush and commutator bar by the instantaneous discharge of the electric energy reduces the durability of the brush and commutator bar.

The rotator includes teeth portions that protrude out along the circumferential direction of the rotational shaft in a discontinuous arrangement. The teeth are wound by the coils and made up of magnetic materials for smoothening the flow of magnetic flux formed by the coil. However, the magnetic teeth constituting the interior of the coil greatly increase the inductance of the coil.

Accordingly, when the area of the magnetic flux concentrated by the teeth interacts with permanent magnets of the stator corresponding to the rotation of the rotator, noise and vibration occur by a cogging torque.

Furthermore, as the rotator is integrated in the conventional motor, if the type and weight of the motor vary, the manufacturing costs and time of the rotator remarkably increase.

### SUMMARY OF THE INVENTION

A DC motor, according to some embodiments, includes a case, and a stator composed of a stator core fixed in the case and a plurality of permanent magnets fitted in the stator core. A brush is electrically coupled to an external power source. A commutator is electrically coupled to the brush and commutates the current provided from the external power source by interacting with the brush. A rotator includes a rotator core, fixed to a rotational shaft rotatably mounted to the case, and coils that electrically connect to the commutator and wind around the rotator core. At least some portions of the rotator core are made of non-magnetic materials.

### BRIEF DESCRIPTION OF THE DRAWINGS

For a better understanding of the disclosed embodiments, reference should be made to the following detailed description with the accompanying drawings, in which:

FIG. 1 is a cross-sectional view of a direct current (DC) motor, in accordance with some embodiments;

FIG. 2 illustrates a rotator of a DC motor, in accordance with some embodiments;

FIG. 3 is a cross-sectional view of a DC motor, in accordance with some other embodiments; and

FIG. 4 is a cross-sectional view of a DC motor, in accordance with further other embodiments.

### DETAILED DESCRIPTION OF THE EMBODIMENTS

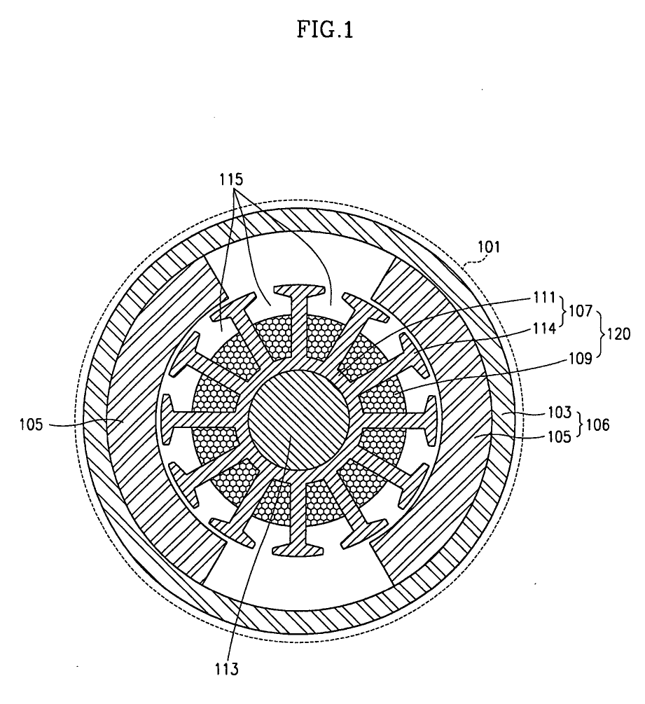

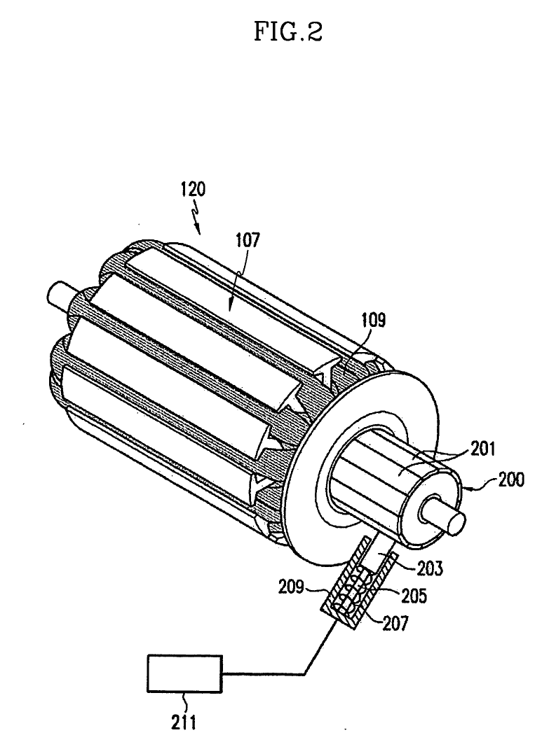

As illustrated in FIGS. 1 and 2, a direct current (DC) motor generating a rotational force by receiving power includes a case 101, stator 106, brush 203, commutator 200, and rotator 120. In exemplary embodiments, case 101 is situated at the outmost portion of the DC motor.

Stator 106 is a magnetic material and includes a stator core 103 and plurality of permanent magnets 105, wherein stator core 103 is fixed in case 101, and permanent magnets 105 are fitted in stator core 103. As stator 106 forms a magnetic field, a strong magnetic field is formed between permanent magnets 105.

Commutator 200 is electrically coupled to brush 203 and commutates the current provided from external power source 211 by interacting with brush 203.

Rotator 120 includes a rotator core 107, commutator 200, and coils 109. Rotator core 107 is fixed to a rotational shaft 113 rotatably mounted to case 101, and coils 109 are electrically coupled to commutator 200 and wind round rotator core 107. At least some portions of rotator core 107 should be made of non-magnetic materials.

Rotator core 107 includes a cylindrical yoke 111 fixed to the periphery of rotational shaft 113. A plurality of teeth 114 onto which coils 109 are wound integrally protrudes out from cylindrical yoke 111. In some embodiments, both cylindrical yoke 111 and teeth 114 are formed with non-magnetic materials.

Brush 203 is electrically coupled to an external power source 211. Brush 203 protrudes from a brush case 209 and contacts a commutator bar 201 of commutator 200 via a supporter 205 and elastic member 207 of brush case 209. When a current is provided from external power source 211, the current is rectified through brush 203 and commutator bar 201 and then is supplied to coils 109.

Slots 115 are formed to place coils 109 between teeth 114.

Coils 109 are electrically connected to commutator 200 and form a magnetic field by the provided current from commutator 200. The magnetic field by coils 109 generates a thrust force by interacting with the magnetic field formed by stator 106. The thrust force rotates rotator 120.

Rotational shaft 113 rotates in accordance with the rotation of rotator 120 and provides rotational force to an external object.

As cylindrical yoke 111 and teeth 114 are made of non-magnetic materials, the inductance of coils 109 wound around teeth 114 remarkably decreases compared to the case where the coils are wound at conventional teeth made of magnetic substances. As a result, the short circuit decreases sufficiently before brush 203 detaches from commutator bar 201, thereby preventing the generation of a spark between brush 203 and commutator 200. The magnetic flux density also decreases due to the non-magnetic teeth 114, thus avoiding the cogging torque, vibration and noise of the motor.

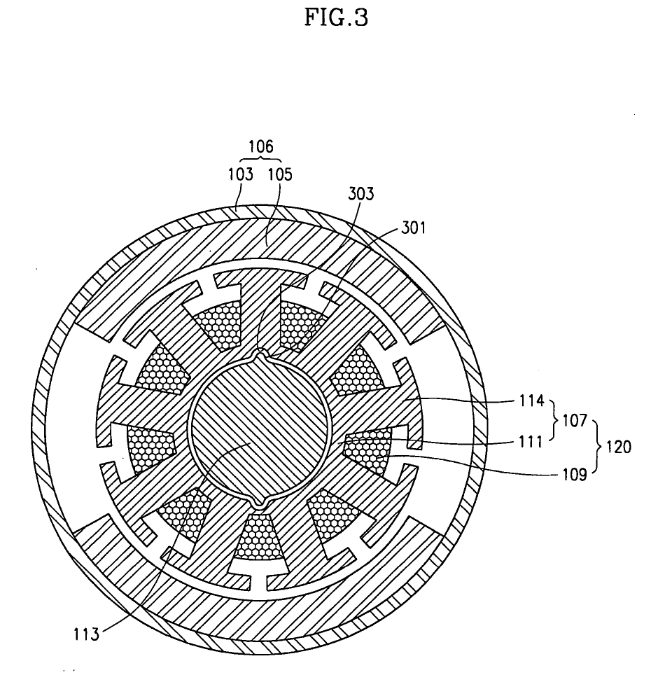

Another embodiment is illustrated in FIG. 3. A groove 303 and protrusion 301 coupled to each other are further provided between the interior of cylindrical yoke 111 and rotational shaft 113 along the longitudinal direction of rotational shaft 113.

The structure of groove 303 and protrusion 301 facilitates the assembly of rotational shaft 113 and rotator core 107 and stabilizes the transmission of the rotational force between rotational core 107 and rotational shaft 113.

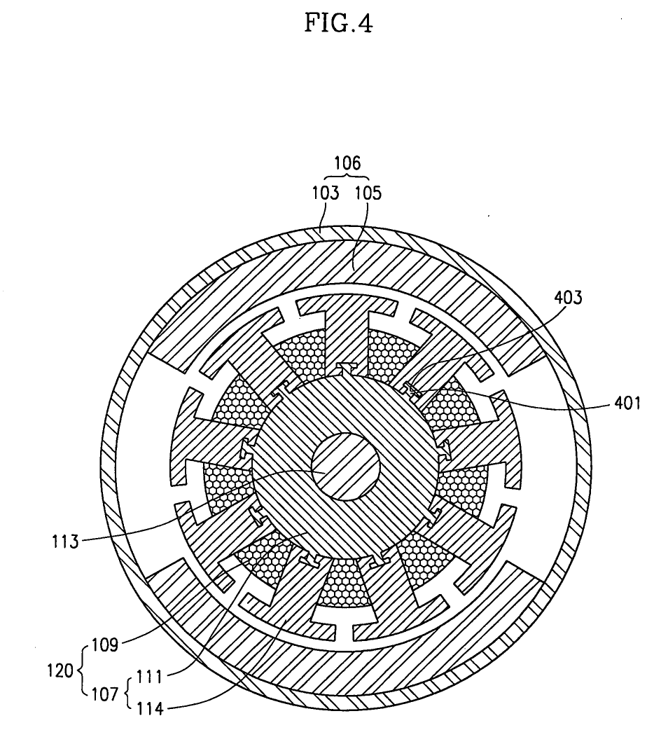

Yet another embodiment is illustrated in FIG. 4. Rotator core 107 includes cylindrical yoke 111 located around rotational shaft 113. The plurality of teeth 114 is made up of non-magnetic materials. Teeth 114 couple to the periphery of cylindrical yoke 111 by grooves and protrusions formed along the longitudinal direction of rotational shaft 113.

At the periphery of cylindrical yoke 111, protrusions 401 having a T-shaped cross section are arranged along the circumferential direction of cylindrical yoke 111 at even intervals. Teeth 114 are formed with grooves 403 having a T-shaped cross section to be inserted by the T-sectioned protrusions 401.

The above structure may regulate the number of teeth 114 coupled to cylindrical yoke 111 or change the diameter of cylindrical yoke 111, thereby enabling it to embody various shapes of the rotator.

Consequently, the manufacturing time and costs of rotator 120 can greatly be reduced.

As apparent from the foregoing, there is an advantage in that at least some portions of the rotator core are formed with non-magnetic materials, decreasing the inductance of the coil equipped at the rotator. Thus, the generation of the spark between the commutator and brush is prevented, and the durability of the brush and commutator is improved.

Furthermore, as the teeth of the rotator core are made up of non-magnetic materials, the magnetic flux density is decreased and the cogging torque is prevented, thereby eliminating noise and vibration thereof.

Still further, the rotator is manufactured with a yoke and a plurality of teeth as separate parts, so that various types of rotators can easily be implemented, resulting in a reduction of the manufacturing costs and time of the motor.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A direct current motor, comprising:
a case;
a stator including a stator core, fixed in said case, and a plurality of permanent magnets fitted in said stator core;
a brush electrically coupled to an external power source;
a commutator electrically coupled to said brush and configured to commutate a current provided from said external power source by interacting with said brush; and
a rotator including a rotational shaft rotatably mounted to said case, a rotator core fixed to said rotational shaft, and one or more coils that electrically connect to said commutator and wind around said rotator core, wherein at least some portions of said rotator core are made of non-magnetic materials.

2. The direct current motor of claim 1, wherein said rotator core includes:
a cylindrical yoke fixed to a periphery of said rotational shaft; and
a plurality of teeth integrally protruding out from said cylindrical yoke and being wound by said coils, wherein both said cylindrical yoke and said teeth are formed with non-magnetic materials.

3. The direct current motor of claim 2, further comprising:
a groove and a protrusion that are coupled to each other and disposed between an interior of said cylindrical yoke and said rotational shaft along a longitudinal direction of said rotational shaft.

4. The direct current motor of claim 1, wherein said rotator core includes:
a cylindrical yoke fixed to a periphery of said rotational shaft; and
a plurality of teeth that is made of non-magnetic materials and coupled to a periphery of said cylindrical yoke by grooves and protrusions formed along a longitudinal direction of said rotational shaft.

5. The direct current motor of claim 4, wherein said protrusions have a T-shaped cross section and are arranged at the periphery of said cylindrical yoke along a circumferential direction of said cylindrical yoke within even intervals, and said grooves have a T-shaped cross section and are formed in said teeth to be inserted by said T-shaped protrusions.
